(19) United States
(12) Patent Application Publication
(10) Pub. No.: US 2011/0191549 A1
(43) Pub. Date: Aug. 4, 2011

(54) Data Array Manipulation

(75) Inventors: Vassily Lyutsarev, Cambridge (GB); Dmitry Voitsekhovskiy, Moscow (RU); Sergey Berezin, Moscow (RU); Martin Calsyn, Cambridge (GB); Alexander Brãndle, Cambridge (GB)

(73) Assignee: Microsoft Corporation, Redmond, WA (US)

(21) Appl. No.: 12/698,654

(22) Filed: Feb. 2, 2010

(51) Int. Cl. G06F 12/00; G06F 12/02; G06F 12/06

(52) U.S. Cl. 711/154; 711/170; 711/E12.001; 711/E12.084

(57) ABSTRACT

Data array manipulation is described. In an embodiment, concurrent access to a multi-dimensional data array stored on a storage device is enabled by providing separate computational elements with access to a model of the data array for processing the data and consequently request changes to the model. The data array is updated in accordance with the changes, and notification of the changes is provided to the other computational elements concurrently accessing the model. In another embodiment, a data interface apparatus is provided that comprises a storage interface that generates a model of the data array, and an application interface that provides access to the model to the computational element for processing. The application interface receives changes to the model resulting from the processing, and a command to commit the changes to the data array. The storage interface then writes the changes to the data array as an atomic operation.

### BACKGROUND

Scientific data such as, for example, satellite imagery, weather simulations or climate change data is often stored in the form of very large multi-dimensional data arrays. The applications or programs that utilize and process the scientific data therefore include functionality to store, retrieve and transfer large amounts of data in the form of these multi-dimensional arrays. Many different file formats exist for storing the data arrays, which range from simple comma separated value files, to bespoke application-specific data storage formats with specialized access protocols for retrieving data.

However, such techniques for storing and accessing large multi-dimensional arrays introduce limitations into the applications or programs accessing the data. For example, the different file formats are incompatible, meaning that an application or program designed to operate on data arrays in one format cannot use other types of files.

Furthermore, if multiple applications or programs are performing computations on the same data arrays, then it is desirable for results coming from one application become input data for other applications. However, the above-mentioned techniques for storing and accessing large multi-dimensional arrays do not facilitate such combinations of computations. For example, there is a lack of a synchronization mechanism, such that, for many data formats, it is not possible for two or more programs to concurrently write data in the same data array. In addition, there is a lack of consistency checking or fault tolerance for the data arrays. For example, an erroneous program can generate an inconsistent data set which subsequently cannot be processed by other programs or an abnormal termination of a program can lead to a loss of the whole generated data array.

The embodiments described below are not limited to implementations which solve any or all of the disadvantages of known data array storage and access techniques.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Data array manipulation is described. In an embodiment, concurrent access to a multi-dimensional data array stored on a storage device is enabled by providing separate computational elements with access to a model of the data array for processing the data and consequently request changes to the model. The data array is updated in accordance with the changes, and notification of the changes is provided to the other computational elements concurrently accessing the model. In another embodiment, a data interface apparatus is provided that comprises a storage interface that generates a model of the data array, and an application interface that provides access to the model to the computational element for processing. The application interface receives changes to the model resulting from the processing, and a command to commit the changes to the data array. The storage interface then writes the changes to the data array as an atomic operation.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates an example of a data set with a multi-dimensional data array and metadata arrays;

FIG. 2 illustrates a schematic diagram of a data interface for accessing data arrays stored in a plurality of file formats;

FIG. 3 illustrates a flowchart of a process for manipulating a stored data array using the data interface;

FIG. 4 illustrates a schematic diagram of a system for enabling concurrent access to a stored data array;

FIG. 5 illustrates a flowchart of a process for providing concurrent access to a stored data array; and

FIG. 6 illustrates an exemplary computing-based device in which embodiments of the data array manipulation technique can be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a system for processing scientific data, the system described is provided as an example and not a limitation. As those skilled in the art will appreciate, the present examples are suitable for application in a variety of different types of data processing systems.

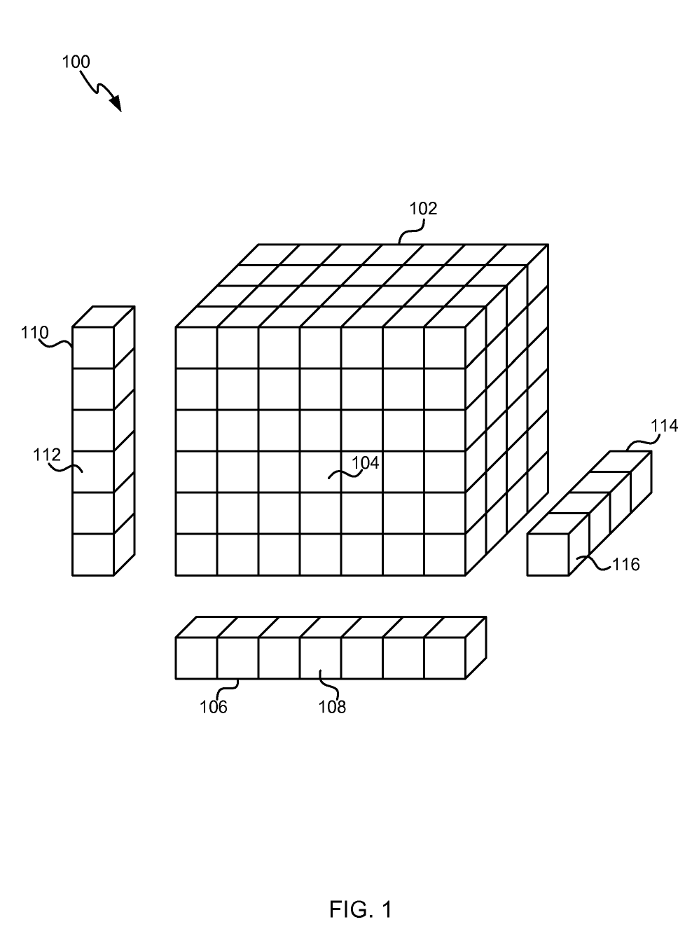

FIG. 1 illustrates an example multi-dimensional data array and associated metadata arrays of the type used for storing scientific data. A data set 100 comprises a multi-dimensional data array 102 (i.e. a data array having more than one dimension). In the example of FIG. 1, the data array 102 has three dimensions. The data array 102 comprises a plurality of data values, such as data value 104.

Associated with the data array 102 are metadata arrays that describe the data stored within the data array 102. For example, metadata array 106 describes the x-axis of the data array 102 and comprises a plurality of values (such as value 108). Metadata array 110 describes the y-axis of the data array 102 and comprises a plurality of values (such as value 112). Metadata array 114 describes the z-axis of the data array 102 and comprises a plurality of values (such as value 116).

As an illustrative example, data set 100 can be used to represent a temperature map in a given three-dimensional region. In this example, each data value within the data array 102 represents a temperature. The x-axis of the data array represents latitude, the z-axis represents longitude, and the y-axis represents height above sea level. In isolation, the data array 102 only provides temperature values, and does not place these in the context of an actual location. For example, the data value 104 gives a certain temperature value, but all that is known about this is that it is indexed in the array with an x-value of 4, a y-value of 3, and a z-value of 1.

The metadata arrays provide the context for the data values. The values within the metadata arrays can provide measurement values for the corresponding elements of the data array 102. For example, in the temperature map example, the metadata arrays provide the latitude, longitude and height values for each temperature value in the data array 102. In other words, for the temperature value given by data value 104, the latitude of the this measurement can be found from the corresponding value 108 (at index 4) of metadata array 106, the longitude of the this measurement can be found from the corresponding value 112 (at index 3) of metadata array 110, and the height of the this measurement can be found from the corresponding value 116 (at index 1) of metadata array 114.

Note that this is merely an example only, and the data set 100 can be larger and comprise more dimensions. In addition, the data array 102 can comprise more that just individual data values in each entry. In examples, the data array 102 can itself comprise several data values and/or one or more arrays at each entry (rather than just a data value) provided that the structure of all entries in the array are consistent. Each of the arrays at each entry can itself be a multi-dimensional array. In further examples, a data array time series can be produced, such that a plurality of multi-dimensional data arrays are stored, each comprising data values from a certain instance of time. In general terms, the data set can be considered to be a set of interrelated arrays.

A feature of data sets comprising multi-dimensional arrays such as data set 100 illustrated in FIG. 1 is the sharing of dimensions between the arrays. In other words, the structure of the arrays is such that there is commonality between a certain dimension of one array, and a certain dimension of another array. For example, in FIG. 1, despite there being one three-dimensional array and three one-dimensional arrays, there are not six different values for the dimensions. Rather, there are only three different values. This is because each dimension of the data array 102 is tied to the dimension of the corresponding metadata array. In other words, the x-dimension of the data array 102 is shared with the metadata array 106, the y-dimension of the data array 102 is shared with the metadata array 110, and the z-dimension of the data array 102 is shared with the metadata array 114.

In addition or alternatively, dimensions can be shared between data arrays (and not just with metadata arrays). For example, if each element within data array 102 was itself an array, then each of these arrays can share dimensions. In other words, each of the arrays within the data array 102 is of the same size and shape. In another example, if a time series of data arrays is stored, then each data array in the time series can share dimensions with each of the other data arrays in the time series.

The sharing of dimensions between arrays can be used as a constraint in data array manipulation to increase the consistency and robustness, as described in more detail hereinafter.

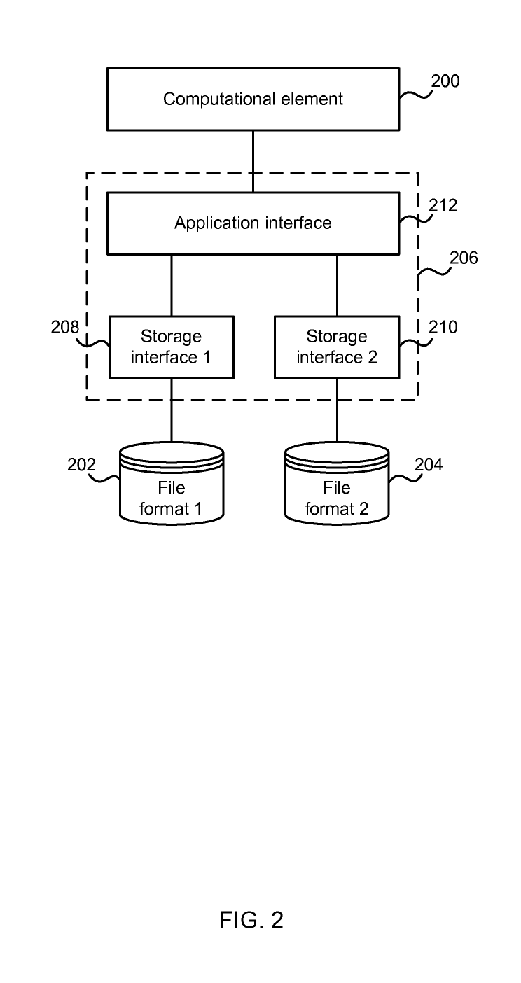

Reference is now made to FIG. 2, which illustrates a schematic diagram of a data interface that enables data arrays (such as those shown in FIG. 1) to be accessed and manipulated in a consistent and fault-tolerant way, even when stored in a plurality of file formats. FIG. 2 shows a computational element 200, which is arranged to perform a computation on data that is stored in a plurality of data arrays. The computational element 200 can be in the form of an executable application or computer program (or a portion of a larger application or computer program).

The computational element 200 performs its computation on a plurality of multi-dimensional data arrays. However, in the example of FIG. 2, these data arrays are stored in a plurality of file formats. FIG. 2 shows the data arrays stored in a first file format 202 and a second file format 204. In other examples, the data arrays can be stored in more file formats. Note that whilst the data arrays are stored in a plurality of file formats, they can be stored on the same physical storage device, on separate storage devices (which can be local or remote from each other), or can come from other sources/consumers of data such as (but not limited to) measurement equipment, user interface controls, and web services.

Because the data arrays are stored in a plurality of file formats, the computational element 200 would previously be configured to read and write to the specific file formats used. This meant that if a data array was stored in a file format for which the computational element 200 had not been configured, then the computational element 200 could not access the data array.

To avoid this, a data interface 206 is used to convert the plurality of data arrays stored in a plurality of file formats into a single model of the data arrays that the computational element can understand. The model has a predefined capabilities that is compatible with the computational element (i.e. the computational element is able to read from, write to, and computationally manipulate a model in this format). The data interface 206 comprises a plurality of storage interfaces that are arranged to transform data arrays stored in a certain file format into a model of the data arrays when reading the data arrays, and transform the model to the file format when writing. The data interface 206 can be provided with an extensible set of storage interfaces, each corresponding to a certain storage file format or a certain access protocol. For example, in the case of FIG. 2, a first storage interface 208 is configured to read and write data arrays stored in the first file format 202 and a second storage interface 210 is configured to read and write data arrays stored in the second file format 204.

Each storage interface therefore generates a model of the data arrays from a certain file format, so that a consistent single model of the data arrays can be used by the computational element 200. The storage interfaces can be dynamically loaded, such that they are instantiated and used as appropriate to access certain data arrays having a certain file format. Therefore, different executions of the same computational element 200 can use data arrays in different file formats by dynamically loading different storage interfaces in each execution.

The model of the data arrays can comprise either all of the data values from the data arrays, or a selected portion of the data values in the data arrays. In some examples, the model of the data arrays comprises a shape descriptor providing a representation of the shape of some or all of the stored data values, and provides a set of operations to manipulate some or all of the data values from the data arrays, but these are abstracted from the storage file format.

The data interface 206 also comprises an application interface 212 that communicates with the storage interfaces and the computational element 200. The application interface 212 is in the form of an application programming interface (API), which provides abstract object models that allows the computational element 200 to instantiate and manipulate the data in memory. In other words, the application interface 212 presents a single, consistent interface to the computation element 200 to enable it to manipulate the model of the data arrays, which can be stored in a plurality of file formats (but this is transparent to the computational element). Therefore, in a single execution run, a computational element can manipulate data stored in several different file formats with a single interface, irrespective of the file formats used and without requiring any knowledge of the way the data arrays are stored.

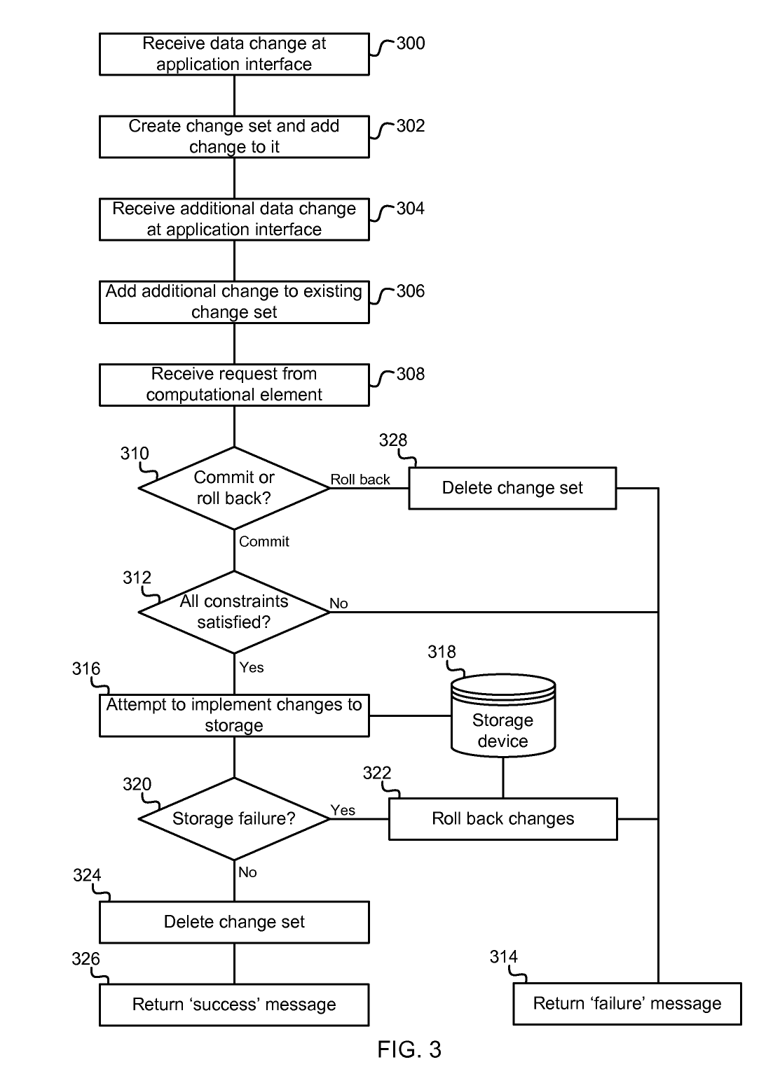

Reference is now made to FIG. 3, which illustrates a flowchart of a process for manipulating a stored data array using the data interface 206 of FIG. 2. Prior to the process shown in FIG. 3, the appropriate storage interfaces for the file format of the stored data arrays have been loaded (e.g. storage interface 208 and/or storage interface 210), the model of the data arrays instantiated, and the computational element 200 has used the application interface 212 to read at least a portion of the data in the model and perform a computation using the data. FIG. 3 illustrates the process performed when the computational element 200 wants to write data back to the data arrays as a result of the processing performed.

Firstly, a change to the data in the model is received 300 from the computational element 200 at the application interface 212. The change to the model data can be in the form of a change to one or more data values in the model, the addition of a new data element to the model, an addition of a data row or column to the model, an addition of a multidimensional slice to the model, the deletion of a data element, the deletion of a data row or column from the model, and/or the deletion of a multidimensional slice from the model. The above mentioned types of changes can be applied to either or both of the data arrays or metadata arrays. Furthermore, the change can also be in the form of the creation of a whole new data array, optionally with metadata.

Responsive to receiving the change to the data in the model, the application interface 212 creates 302 a temporary change set and adds the received change to the change set. The change set acts as a repository for storing a plurality of changes to the model so that they can be checked before being sent to the storage device.

Optionally, the change set can collect several consecutive changes requested by the computational element 200 before taking any further action, as illustrated in FIG. 3. FIG. 3 shows an additional change to the model data being received 304 at the application interface 212 from the computational element 200. This additional change is added 306 to the existing change set. Note, however, that FIG. 3 is merely an example, and in other examples only a single change could be received at the application interface 212, or more than two changes could be received.

In order for the data changes in the change set to be committed to the source data arrays stored on the storage device in the original file format, the computational element issues a ‘commit’ request message to the application interface. Alternatively, to abandon the changes in the change set without committing them to the storage device, the computational element 200 can issue a ‘roll back’ request to the application interface 212. These request messages can be issued directly or indirectly by the computational element (e.g. as an explicit request issued by the computational element, or an automatically generated request issued as a result of, for example, reaching a certain number of changes sent to the application interface or a certain time since the previous request message).

When a request message is received 308 at the application interface 212 from the computational element 200, it is determined 310 whether the request message is a ‘commit’ request or a ‘roll back’ request. If it is a ‘commit’ request, then it is determined 312 whether the changes to the data model in the change set comply with (i.e. satisfy) certain predefined constraints. For example, the application interface 212 performs consistency checks on the changes in the change set. This can be achieved by virtually applying the changes in the change set to the schema of the data arrays stored on the storage device (i.e. without making any actual changes to the stored data arrays) and performing consistency checks. As mentioned above, the presence of shared dimensions can be used to perform the consistency checks. For example, the application interface 212 can determine that after the changes are applied, the resulting arrays have shapes that satisfy the shared dimensions constraints. In other words, for any two arrays that prior to the changes had a shared dimension, checking that their sizes along the shared dimension are equal after the change is applied.

If it is determined 312 that the constraints (such as shared dimension constraints) are not satisfied in the change set, then no changes are made to the stored data arrays, and a ‘failure’ message is returned 314 to the computational element 200 from the application interface 212.

If, however, it is determined 312 that the constraints are satisfied, then the changes to the data in the change set can be applied to the stored data arrays. The writing of the changes to the stored data arrays is performed as an atomic operation. In other words, the writing to the stored data arrays is performed as a single ‘all or nothing’ operation, such that either the complete set of changes are written to the stored data arrays in their entirety, or no changes are made to the stored data arrays at all. This ensures that partial changes are not made to stored data arrays. The atomic storage operation enforces a transactional approach to modification of the data on the storage device, which significantly increases data storage tolerance to errors and faults.

To achieve the atomic write operation, firstly an attempt 316 is made to write the changes to the storage device 318 on which the original, source data arrays are stored. This is performed by the application interface 212 issuing a write command to the appropriate storage interface 208, 210 associated with the data array that is being changed. The storage interface 208, 210 converts the changes to the model to an equivalent change to the data array in the appropriate file format, and attempts to write the changes to the storage device 318 in the appropriate file format. It then determines 320 whether the changes in the change set were successfully written to the storage device 318.

Note that whilst FIG. 3 only illustrates a single storage device 318, in other examples the write operation can comprise writing data to several separate storage devices. In addition, the write operation can comprise writing data to a plurality of data arrays stored in different file formats, in which case a plurality of storage interfaces are used in accordance with the file formats present.

If the changes were not successfully written to the storage device 318 (i.e. there was a storage failure) then the changes are rolled back 322, so that the data in the data arrays on the storage device 318 are reverted to their state prior to attempting to apply the changes. All changes from the change set are rolled back to ensure that no partial changes to the data arrays are made. Once the changes are rolled back, a ‘failure’ message is returned 314 to the computational element 200 from the application interface 212.

If the changes were all successfully written to the storage device 318 (i.e. there was no storage failure) then the atomic storage operation was successful, and the change set is deleted 324. The change set can be deleted as the data it contained has now been written to the data arrays on the storage device 318. A ‘success’ message is then returned 326 to the computational element 200 from the application interface 212 to notify it that the changes have been correctly applied.

Returning again to when a request message is received 308 at the application interface 212 from the computational element 200, if it is determined 310 that the request message is a ‘roll back’ request, then the change set is deleted 328 (without the changes being written to the storage device). A ‘failure’ message is then returned 314 to the computational element 200 from the application interface 212.

The use of shared dimension constraints together with a transactional (atomic) approach to the modification of data arrays stored on the storage device 318 leads to dramatic increase in storage robustness. The use of the data interface 206 when manipulating the stored data arrays guarantees that even in presence of catastrophic computational element behavior the stored data arrays remain in a consistent state. Only correct changes go to storage, and partial changes or changes that break consistency constraints are rejected. This behavior is built at the core of the data interface 206 and cannot be altered by the computational element 200.

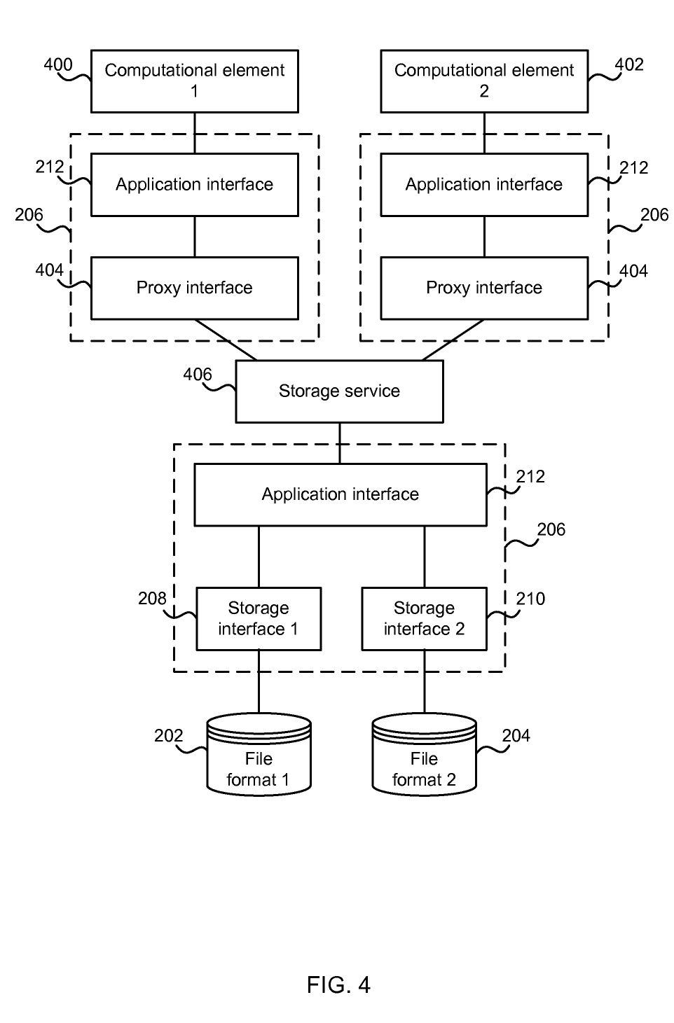

Reference is now made to FIG. 4, which illustrates a schematic diagram of a system for enabling concurrent access to a stored data array. In the example of FIG. 4, two computational elements (a first computational element 400 and a second computational element 402) are concurrently accessing data arrays stored in a plurality of file formats (a first file format 202 and second file format 204). In other examples, more than two computational elements can be concurrently accessing the data arrays, and the data arrays can be stored in more or fewer file formats. The computational elements concurrently accessing the data arrays can be, for example, different applications/programs, multiple running instances of a program, or concurrently executed threads of the same program. In addition, the computational elements can, in one example, all run on the same computing device with the data storage, or, in another example, one or more computational elements can run on a remote computing device connected via a communication network.

Each computational element independently works with its own instance of a data interface 206 (as described above). Therefore, each computational element has its own instance of a data model that it can access, and its own change set that is generated as changes are made to the model. However, the data interfaces communicating with the computational elements do not directly write to the stored data arrays. Therefore, a storage interface to a file format is not used at these data interfaces. Instead a proxy interface 404 is provided at these data interfaces.

The proxy interface 404 is a specific type of storage interface that is arranged to communicate with a storage service 406 rather than a stored data array in a certain file format. The storage service 406 is a software program that communicates with a data interface 206 that provides the interface to the storage device (or devices) where the data arrays are stored (in the first file format 202 and second file format 204 in FIG. 4). Therefore, the storage service owns the ‘real’ instance of the data interface 206 that actually handles the data stored on the storage device (or devices). This data interface 206 maintains its own model of the data and its own change set, and loads the appropriate storage interface 208, 210 (or interfaces) for the file formats used to store the data arrays.

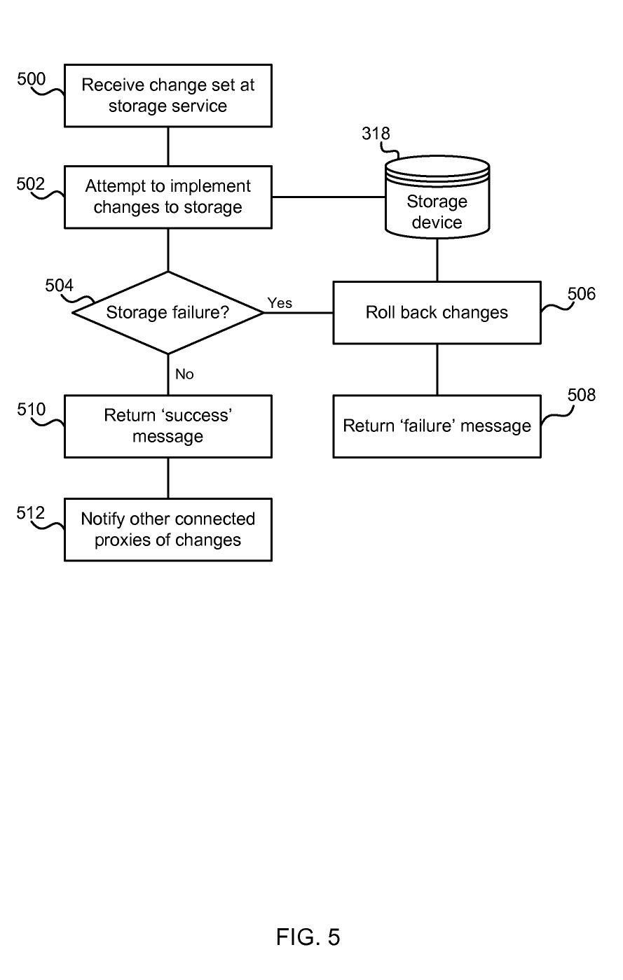

The single storage service 406 acts as the link between the computational elements concurrently accessing the same data arrays, and enables live communication between the computational elements, as described in more detail below with reference to FIG. 5. Each proxy interface 404 forwards requests for data from the computational element 400, 402 to the single storage service 406, and the storage service 406 executes the request and returns the requested data as a reply message. Note that the form of communication between the storage service and the proxy interface depends on the relative locations of these elements. For example, if the storage service and proxy interface are being executed on a single computing device as one process, then the communication can be in the form of procedure calls. Alternatively, if the storage service and proxy interface are located on remote computing devices, then the communication can be in the form of a series of messages sent over a communication network using a network protocol.

FIG. 5 illustrates a flowchart of a process for providing concurrent access to a stored data array using the storage service 406 and arrangement of data interfaces shown in FIG. 4. When a computational element (for example the first computational element 400 in FIG. 4) issues change requests they are collected in a change set by the data interface 206 connected to the computational element, as described above with reference to FIG. 3. When the first computational element 400 issues the ‘commit’ command, the proxy interface 404 forwards the whole change set to the storage service 406 in a change request message.

When the change set is received 500 at the storage service 406, the storage service 406 uses the data interface 206 connected to the stored data arrays to store the change set as an atomic operation (as outlined with reference to FIG. 3). To do this, the storage service 406 sends the change set to data interface 206 and issues a ‘commit’ command to request the data interface to update the data arrays in accordance with the change set.

The data interface 206 then attempts 502 to write the changes to the storage device 318 (or devices) on which the data arrays are stored. This is performed by the application interface 212 issuing a write command to the appropriate storage interface 208, 210 associated with the data array that is being changed. The storage interface 208, 210 converts the changes to an equivalent change to the data array in the appropriate file format, and attempts to write these to the storage device 318. It is then determined 504 whether the changes in the change set were successfully written to the storage device 318.

Note that this operation can comprise writing data to several separate storage devices. In addition, the write operation can comprise writing data to a plurality of data arrays stored in different file formats, in which case a plurality of storage interfaces are used in accordance with the file formats present.

If the changes were not successfully written to the storage device 318 (i.e. there was a storage failure) then the changes are rolled back 506, so that the data in the data arrays on the storage device 318 are reverted to their state prior to attempting to apply the changes. All changes from the change set are rolled back to ensure that no partial changes to the data arrays are made. Once the changes are rolled back, a ‘failure’ message is transmitted 508 to the computational element 400 via the storage service 406.

If the changes were all successfully written to the storage device 318 (i.e. there was no storage failure) then the atomic storage operation was successful, and a ‘success’ message is transmitted 510 to the computational element 400 via the storage service 406 to notify it that the changes have been correctly applied.

In addition, responsive to determining that the changes were all successfully written to the storage device 318 a notification message is transmitted 512 from the storage service 406 to each of the other computational elements concurrently accessing the data arrays (i.e. all of the computational elements except the one that requested the change). The notification message is sent to the proxy interface 404 of each of the other computational elements. The notification message comprises the change that was successfully made to the stored data arrays, and enables the data interfaces of the other computational elements to update their local model of the data accordingly.

Therefore, live communication between the computational elements is achieved, because once a change is successfully made to the data arrays, the other computational elements are informed of the change. Hence, the other computational elements are able to learn of the changes and react to the update through an event mechanism.

If the storage service 406 receives several requests from different proxy interfaces at the same time, it puts them in a queue and implements sequentially, one by one. This makes unnecessary additional resource locking, and prevents conflicts from concurrent use of the actual data storage.

Each data interface 206 shown in FIG. 5 applies the constraint checking and transactional write mechanisms outlined above with reference to FIG. 3, and therefore the technique for providing concurrent access to the stored data arrays outlined above also maintain robustness and fault tolerance.

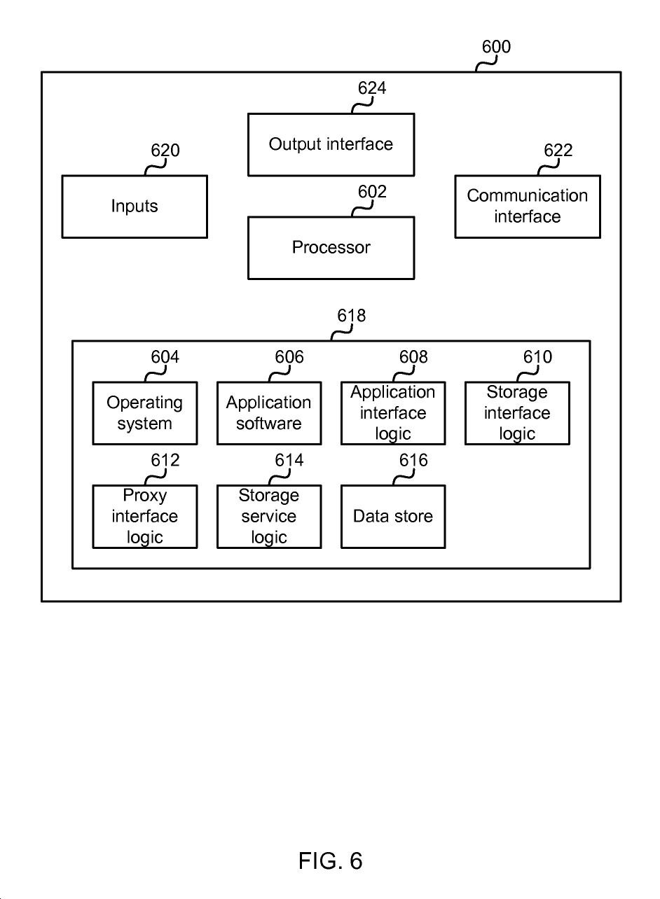

Reference is now made to FIG. 6, which illustrates various components of an exemplary computing-based device 600 which can be implemented as any form of a computing and/or electronic device, and in which embodiments of the data array manipulation techniques can be implemented. The computing-based device 600 of FIG. 6 is illustrated comprising the functionality of several elements of the systems in FIG. 2 and FIG. 4, such as the data interface 206, storage service 406, and computational element 200, 400, 402. However, it will be understood that in some examples one or more of these elements can be implemented on separate computing-based devices, and not on a single device as illustrated in FIG. 6

Computing-based device 600 also comprises one or more processors 602 which can be microprocessors, controllers or any other suitable type of processors for processing computing executable instructions to control the operation of the device in order to perform the data array manipulation techniques. Platform software comprising an operating system 604 or any other suitable platform software can be provided at the computing-based device to enable application software 606 to be executed on the device. The application software 606 can comprise data array computation software implementing the computational elements described hereinabove.

Further software that can be provided at the computing-based device 600 includes application interface logic 608, storage interface logic 610 and proxy interface logic 612, which together implement the data interface 206 described above. In addition, storage service logic 614 can be provided to implement the storage service functionality. Note that, optionally, a selection of the above-mentioned software items can be provided at the computing-based device 600, in accordance with its desired function (e.g. as a storage service 406 or a data interface 206 only). A data store 616 is provided to store data such as the change set.

The computer executable instructions can be provided using any computer-readable media, such as memory 618. The memory is of any suitable type such as random access memory (RAM), a disk storage device of any type such as a magnetic or optical storage device, a hard disk drive, or a CD, DVD or other disc drive. Flash memory, EPROM or EEPROM can also be used.

The computing-based device 600 further comprises one or more inputs 620 which are of any suitable type for receiving user input, for example commands to control the computations performed on the data array. The computing-based device 800 also optionally comprises at least one communication interface 622 for communicating with one or more communication networks, such as the internet (e.g. using internet protocol (IP)) or a local network. The communication interface 622 can also be used to communicate with one or more external computing devices (such as those implementing other elements of FIGS. 2 and 4), and with databases or storage devices (such as those storing the multi-dimensional data arrays).

An output 624 is also optionally provided such as an audio and/or video output to a display system integral with or in communication with the computing-based device. The display system can provide a graphical user interface, or other user interface of any suitable type.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A computer-implemented method of providing concurrent access to a multi-dimensional data array stored on a storage device, comprising:
providing a first computational element and at least one further computational element with access to a model of the multi-dimensional data array, the access being provided from a storage service in communication with the storage device and executed on a processor;
receiving, at the storage service, a request message from the first computational element comprising a change to the model;
updating the data array stored on the storage device in accordance with the change to the model; and
responsive to updating the data array, transmitting a notification message comprising the change to the model from the storage service to the at least one further computational element.

2. A method according claim 1, wherein the model comprises a set of operations to manipulate data values from at least a portion of the data array and a shape descriptor for the data values.

3. A method according claim 1, wherein the model comprises data values presented in a predefined format that is compatible with the first computational element and the at least one further computational element.

4. A method according claim 1, wherein the step of updating the data array comprises converting the change to the model to an equivalent change to the data array at a data interface program executed on the processor, and storing the change to the data array on the storage device using an atomic storage operation.

5. A method according claim 4, wherein the step of updating the data array further comprises determining whether the change to the data array was stored successfully.

6. A method according claim 5, wherein the step of updating the data array further comprises, responsive to determining that the change to the data array was stored successfully, transmitting a success message from the storage service to first computational element.

7. A method according claim 4, further comprising the step of generating the model of the data array at the data interface program executed on the processor and providing the storage service with access to the model of the data array.

8. A method according claim 1, wherein the request message comprising the change to the model is received from the first computational element via a data interface program arranged to communicate with the first computational element and the storage service.

9. A method according claim 1, wherein the first computational element and the at least one further computational element are: different computer-executable applications; separate instances of the same computer-executable application; or concurrently executed threads of the same computer-executable application.

10. A data interface apparatus for updating a plurality of multi-dimensional data arrays stored on a storage device, comprising:
a storage interface arranged to communicate with the storage device and generate a model of the data arrays stored on the storage device; and
an application interface arranged to communicate with the storage interface and a computational element, provide the computational element with access to the model for processing, receive and store a plurality of changes to the model from the computational element resulting from the processing, and receive a command from the computational element to commit the changes to the data arrays,
wherein the storage interface is further arranged to write the changes to the data arrays responsive to receiving the command as an atomic operation such that if the changes are not successfully written to the storage device the data arrays are reverted to their state prior to writing the changes.

11. An apparatus according to claim 10, wherein the application interface is further arranged to determine whether changes comply with at least one predefined constraint responsive to receiving the command from the computational element.

12. An apparatus according to claim 11, wherein the predefined constraint is a shared dimension between two or more of the data arrays.

13. An apparatus according to claim 10, wherein the application interface is arranged to provide the computational element with access to the model by presenting a predefined application programming interface to the computation element irrespective of a file format in which the data array is stored on the storage device.

14. An apparatus according to claim 10, wherein the plurality of changes to the model comprise at least one of: a change to a data value within the model; an addition of a data element to the model; an addition of a data row to the model; an addition of a data column to the model; an addition of a multidimensional slice to the model; a deletion of a data element from the model; a deletion of a data row from the model; a deletion of a data column from the model; and deletion of a multidimensional slice from the model.

15. An apparatus according claim 10, wherein the storage interface is arranged to generate the model of the data arrays stored on the storage device in a first file format.

16. An apparatus according claim 15, wherein the apparatus further comprises a second storage interface arranged to generate a further model of further data arrays stored on the storage device in a second file format, and the application interface is further arranged to provide the computational element with access to the further model for processing, receive and store a plurality of changes to the further model from the computational element resulting from the processing, and receive a further command from the computational element to commit the further model changes to the further data arrays, and wherein the second storage interface is further arranged to write the further model changes to the further data arrays responsive to receiving the further command as an atomic operation such that if the changes are not successfully written to the storage device the further data arrays are reverted to their state prior to writing the changes.

17. An apparatus according claim 10, wherein the application interface is arranged to transmit a failure message to the computational element if the changes are not successfully written to the storage device.

18. An apparatus according claim 10, wherein the application interface is arranged to transmit a success message to the computational element if the changes are successfully written to the storage device.

19. An apparatus according claim 18, wherein the application interface is arranged to delete the stored changes if the changes are successfully written to the storage device.

20. A data processing method for concurrently processing a plurality of multi-dimensional data arrays stored on a storage device, comprising:
generating a model of the data arrays stored on the storage device at a data interface in communication with the storage device and executed on a processor;
providing a first application program and at least one further application program executed on the processor with access to the model of the data arrays from a storage service in communication with the data interface and executed on the processor;
concurrently processing the model at the first application program and at the least one further application program;
receiving, at the storage service, a request message from the first application program comprising a change to the model;
converting, at the data interface, the change to the model to an equivalent change to the data arrays at a data interface program executed on the processor, and storing the change to the data arrays on the storage device using an atomic storage operation; and
responsive to storing the change to the data arrays, transmitting a notification message comprising the change to the model from the storage service to the at least one further application program.
